(19) United States
(12) Patent Application Publication
(10) Pub. No.: US 2025/0209155 A1
(43) Pub. Date: Jun. 26, 2025

(54) SECURITY RESERVE MODES FOR CERTIFIED SYSTEMS

(71) Applicant: Rolls-Royce North American Technologies Inc., Indianapolis, IN (US)

(72) Inventors: N. Luke Thomas, Indianapolis, IN (US); Wayne T. Padgett, Indianapolis, IN (US)

(21) Appl. No.: 18/392,907

(22) Filed: Dec. 21, 2023

(51) Int. Cl. G06F 21/55; G06F 16/11; G06F 21/64

(52) U.S. Cl. CPC G06F 21/554; G06F 16/128; G06F 21/64

(57) ABSTRACT

A method includes creating a first image of a software system, creating a second image of the software system including a second code level layout different than the first code level layout, verifying and validating the first and second images of the software system, certifying the first and second images, deploying the first image of the software system on a first operating system, and automatically detecting a first cyberattack being executed on the first image of the software system operating in the first operating system. In response to detecting the first cyberattack being executed on the first image of the software system operating on the first operating system, deploying the second image of the software system on the first operating system in order to disrupt the first cyberattack on the first image of the software system.

### FIELD OF DISCLOSURE

The present disclosure relates generally to computer and software security, and in particular, mitigation and/or prevention of cyberattacks on computer and software.

### BACKGROUND

Cyberattacks may include any type of malicious software or malware that is deployed by an attacker that may be harmful to another piece of software, computer, network of computers, or the like. Malware can include, as non-limiting examples, computer viruses, worms, Trojan horses, adware, spyware, and any programming that gathers information about a computer or its user or otherwise operates without permission. As cyberattacks have evolved over time, more and more complex cybersecurity systems have been developed to defend against the evolving cyberattacks. The need to combat these attacks continues to be an extremely high priority.

Cyberattack may be particularly dangerous for applications requiring high levels of safety, such as transportation vehicles, and in particular, aircraft engines. Aircraft engines of today utilize a wide variety of software in order to operate. Such engines may include gas turbine engines, electric engines, hybrid engines, and the like. Because any malfunction in the software of an aircraft engine can potentially lead to catastrophic failure of the engine, there is a need for sophisticated mitigation and/or prevention of such cyberattacks on aircraft engines.

### SUMMARY

The present disclosure may comprise one or more of the following features and combinations thereof.

According to a first aspect of the present disclosure, a method for mitigating a cyberattack includes automatically creating, via a software image generation tool, a first image of a software system including a first code level layout and configured to output a first system level output based on a first system level input, automatically creating, via the software image generation tool, a second image of the software system including a second code level layout different than the first code level layout and configured to output a second system level output equal to the first system level output based on a second system level input equal to the first system level input, and verifying and validating, via a software verification and validation tool, the first and second images of the software system so as to produce first verification and validation data indicative of the verification and validation of the first and second images.

The method further includes certifying the first and second images based on the first verification and validation data, deploying, via a software deployment management subsystem, the first image of the software system on a first operating system, automatically detecting, via an attack detection tool, a first cyberattack being executed on the first image of the software system operating in the first operating system, and, in response to detecting the first cyberattack being executed on the first image of the software system operating on the first operating system, deploying, via the software deployment management subsystem, the second image of the software system on the first operating system in order to disrupt the first cyberattack on the first image of the software system.

In some embodiments, the automatic verification and validation of the first image of the software system includes receiving initial software specifications and automatically determining whether the first image of the software system meets the initial software specifications.

In some embodiments, the automatic creation of the second image is carried out after the automatic determination of whether the first image of the software system meets the initial software specifications, and the automatic verification and validation of the second image of the software system includes determining whether the second image of the software system meets the initial software specifications.

In some embodiments, the initial software specifications include requirement metrics and target values that the first and second images must meet, and the determination of whether the first and second images meet the initial software specifications includes executing testing of the first and second images and comparing results of the testing to the requirement metrics and target values in order to determine whether the first and second images meet the requirement metrics and target values.

In some embodiments, the method further includes storing, via the software deployment management subsystem, the first verification and validation data in a data store, the first verification and validation data being indicative of the first and second images meeting the requirement metrics and target values of the initial software specifications, compiling, via the software deployment management subsystem, the first verification and validation data in a packaged format, and transmitting, via the software deployment management subsystem, the compiled first verification and validation data to an external certifier to have the first and second images certified.

In some embodiments, the method further includes, in response to detecting that a first cyberattack being executed on the first image of the software system operating in the first operating system, automatically assigning, via the software deployment management subsystem, a severity value to the first cyberattack.

In some embodiments, the severity value is based on a number of a plurality of severity factors present in the first cyberattack, the severity value is a binary number in a specified range of numbers, and the severity value is proportional to the number of the plurality of severity factors present in the first cyberattack.

In some embodiments, the method further includes, in response to detecting that a first cyberattack being executed on the first image of the software system operating in the first operating system, automatically assigning, via the software deployment management subsystem, a risk value of deploying the second image of the software system.

In some embodiments, the risk value is based on a number of a plurality of risk factors of deploying the second image of the software system, the risk value is a binary number in a specified range of numbers, and the risk value is proportional to the number of the plurality of risk factors of deploying the second image of the software system.

In some embodiments, the method further includes, automatically comparing, via the software deployment management subsystem, the severity value with the risk value and, in response to the severity value being greater than the risk value, deploying the second image of the software system.

According to a further aspect of the present disclosure, a method for mitigating a cyberattack includes creating a first image of a software system, creating a second image of the software system different than the first image, automatically verifying and validating the first and second images of the software system, deploying the first image of the software system on a first operating system, receiving an indication that a first cyberattack is being executed or will be executed on the first image of the software system operating in the first operating system, and, in response to receiving the indication that the first cyberattack is being executed or will be executed on the first image of the software system operating on the first operating system, deploying the second image of the software system on the first operating system in order to disrupt the first cyberattack on the first image of the software system.

In some embodiments, the receiving of the indication that the first cyberattack is being executed includes receiving an alert from a customer managing the first operating system that the first cyberattack will be executed on the first image of the software system.

In some embodiments, the receiving of the indication that the first cyberattack is being executed includes detecting that the first cyberattack is being executed on the first image of the software system.

In some embodiments, the creation of the first image of the software system includes creating a first code level layout configured to output a first system level output based on a first system level input, and the creation of the second image of the software system includes creating a second code level layout different than the first code level layout configured to output a second system level output equal to the first system level output based on a second system level input equal to the first system level input.

In some embodiments, the automatic verification and validation of the first image of the software system includes receiving initial software specifications and automatically determining whether the first image of the software system meets the initial software specifications, the creation of the second image is carried out after the automatic determination of whether the first image of the software system meets the initial software specifications, and the automatic verification and validation of the second image of the software system includes determining whether the second image of the software system meets the initial software specifications.

In some embodiments, the initial software specifications include requirement metrics and target values that the first and second images must meet, and the determination of whether the first and second images meet the initial software specifications includes executing testing of the first and second images and comparing results of the testing to the requirement metrics and target values in order to determine whether the first and second images meet the requirement metrics and target values.

In some embodiments, the method further includes, in response to detecting that a first cyberattack being executed on the first image of the software system operating in the first operating system, automatically assigning a severity value to the first cyberattack. The severity value is based on a number of a plurality of severity factors present in the first cyberattack, the severity value is a binary number in a specified range of numbers, and the severity value is proportional to the number of the plurality of severity factors present in the first cyberattack.

In some embodiments, the method further includes, in response to detecting that a first cyberattack being executed on the first image of the software system operating in the first operating system, automatically assigning a risk value of deploying the second image of the software system. The risk value is based on a number of a plurality of risk factors of deploying the second image of the software system, the risk value is a binary number in a specified range of numbers, and the risk value is proportional to the number of the plurality of risk factors of deploying the second image of the software system.

In some embodiments, the method further includes, automatically comparing the severity value with the risk value and, in response to the severity value being greater than the risk value, deploying the second image of the software system.

According to a further aspect of the present disclosure, a system for mitigating a cyberattack includes a software image generation tool, a software verification and validation tool, a software deployment management subsystem, and an attack detection tool. The software image generation tool is configured to automatically create a first image of a software system including a first code level layout and configured to output a first system level output based on a first system level input, and configured to automatically create a second image of the software system including a second code level layout different than the first code level layout and configured to output a second system level output equal to the first system level output based on a second system level input equal to the first system level input.

The software verification and validation tool is configured to automatically verify and validate the first and second images of the software system so as to produce first verification and validation data indicative of the verification and validation of the first and second images. An external certification processor is configured to certify the first and second images based on the first verification and validation data. The software deployment management subsystem is configured to deploy the first image of the software system on a first operating system, and the attack detection tool is configured to detect a first cyberattack being executed on the first image of the software system operating in the first operating system. The software deployment management subsystem is further configured to, in response to detecting the first cyberattack being executed on the first image of the software system operating on the first operating system, deploy the second image of the software system on the first operating system in order to disrupt the first cyberattack on the first image of the software system.

These and other features of the present disclosure will become more apparent from the following description of the illustrative embodiments.

### BRIEF DESCRIPTION OF THE DRAWINGS

FIG. 1 is a flow diagram of a method for mitigating a cyberattack according to the present disclosure, including operational steps of creating multiple images of software, automatically verifying and validating the software images, certifying the software images, deploying a first image of the software, detecting a cyberattack, and deploying a second, subsequent image of the software in response to detecting the cyberattack;

FIG. 2 is a conceptual diagram of a system configured to carry out the method for mitigating a cyberattack of FIG. 1, showing that the system can include an aircraft, development level systems including a software image generation tool, a software verification and validation tool, and a software deployment management tool;

FIG. 3A is a flow diagram of a process of automatically verifying and validating the multiple software images of the method and system of FIGS. 1 and 2;

FIG. 3B is a conceptual diagram of multiple images of the software of the method and system of FIGS. 1 and 2, showing that the software stack of the multiple images may be organized in different code arrangements while ultimately producing the same output;

FIG. 4 is a flow diagram of a process of evaluating an attack and deploying a second image of the software of the method and system of FIGS. 1 and 2;

FIG. 5 is a flow diagram of a process of certifying the multiple software images of the method and system of FIGS. 1 and 2;

FIG. 6 is a conceptual diagram of an aircraft including two engines configured to utilize the method and system of FIGS. 1 and 2;

FIG. 7 is a schematic diagram that shows an example of a computing device and a mobile computing device that may be embodied as one or more of the components of the system of FIG. 2; and

FIG. 8 is a flow diagram of a method for mitigating a cyberattack according to a further aspect of the present disclosure, including operational steps of creating multiple images of software, automatically verifying and validating the software images, certifying the software images, deploying a first image of the software, detecting a cyberattack, and deploying a second image of the software in response to detecting the cyberattack.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

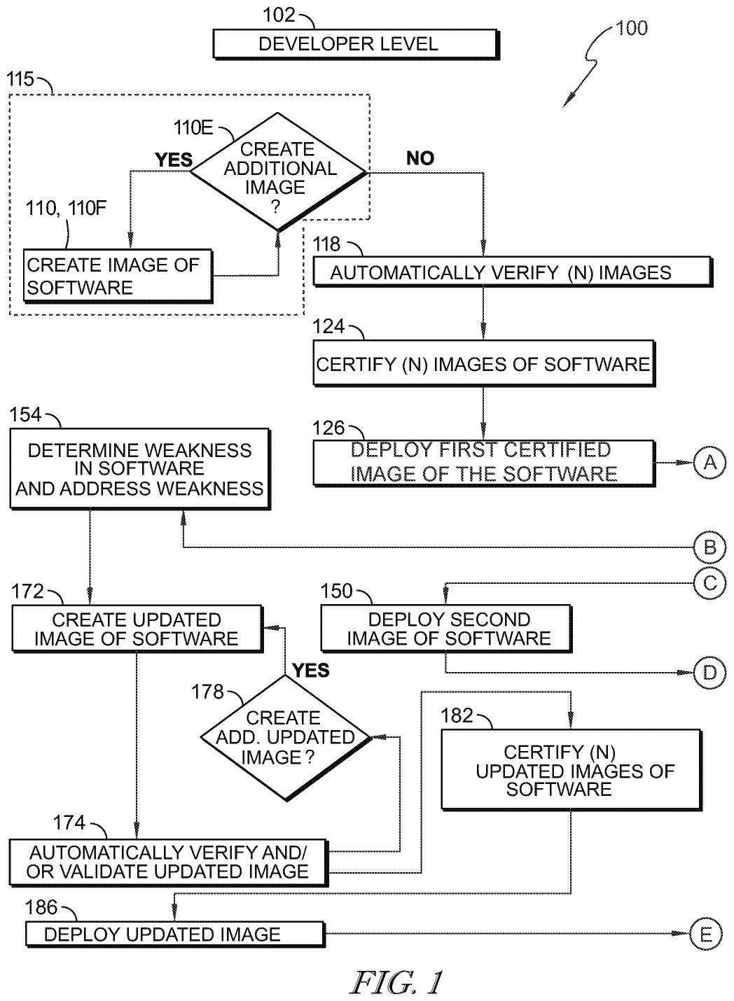

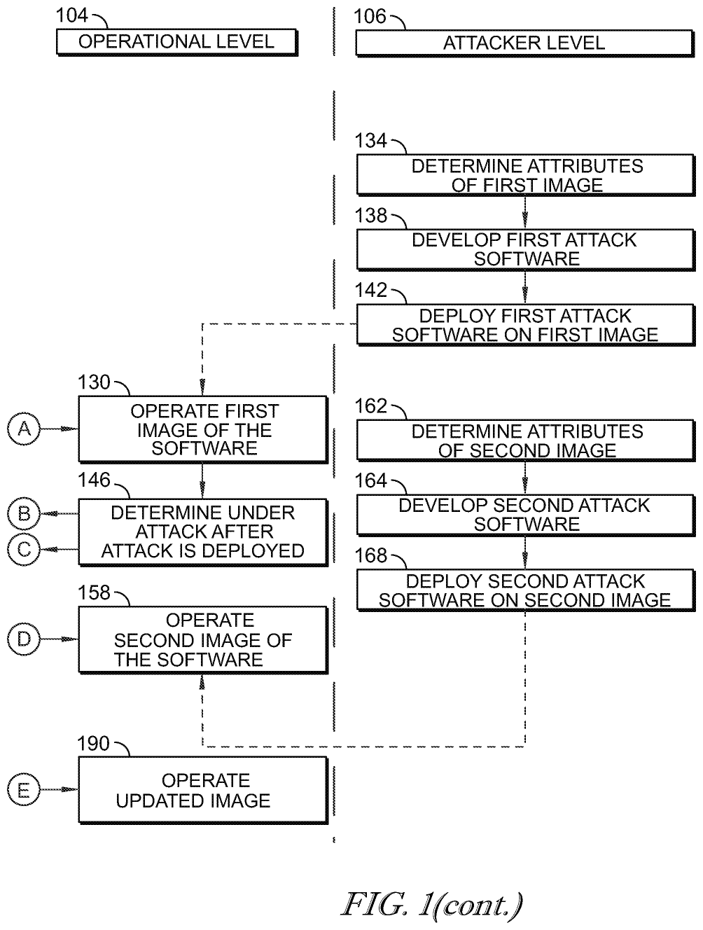

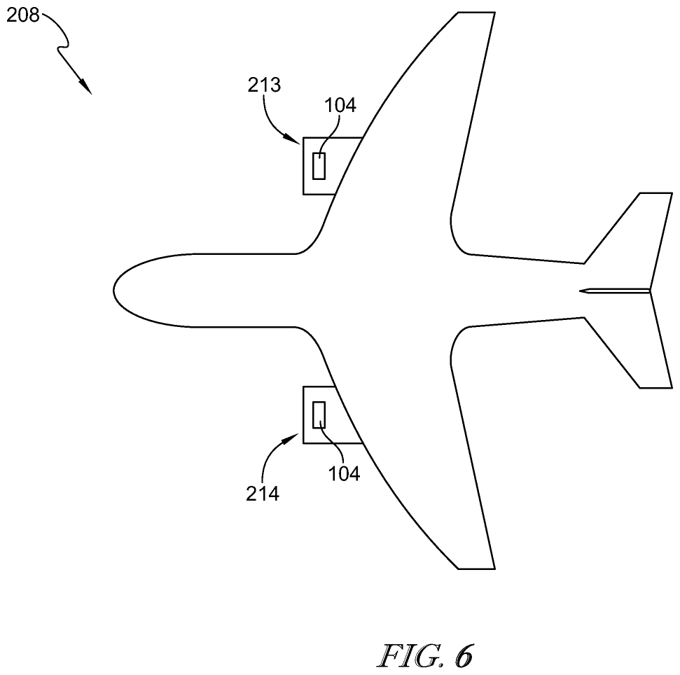

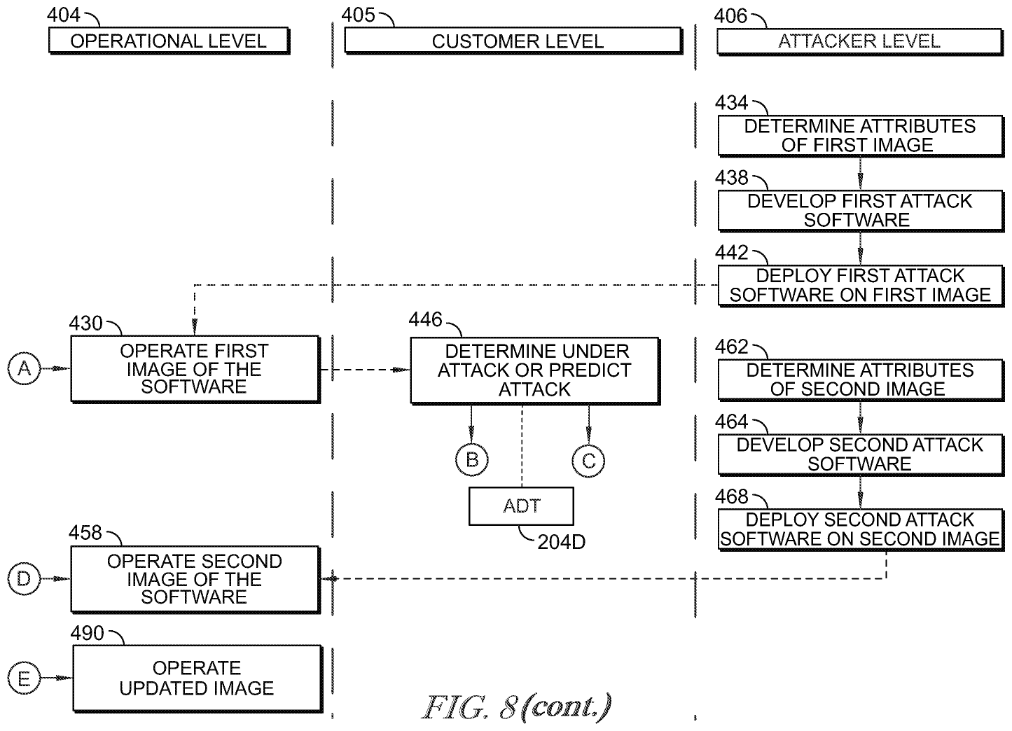

A method 100 for mitigating a cyberattack and system 200 for carrying out the method 100 according to a first aspect of the present disclosure is shown in FIGS. 1-7. A method 400 for mitigating a cyberattack according to a further aspect of the present disclosure is shown in FIG. 8. Although the methods 100, 400 and system 200 described herein will be described with reference to aircrafts and aircraft engines, such as the aircraft 208 and engines 213, 214 shown in FIG. 6, a person skilled in the art will understand that the methods 100, 400 and system 200 may be utilized in other safety critical systems and applications that may benefit from the improved security and image deployment of the disclosed methods 100, 400 and system 200. Such alternative applications may include other types of transportation vehicles and power generation applications.

Similar to other components of an aircraft, software that is utilized on aircraft, such as the software utilized by the aircraft's engines, must demonstrate adherence to strict compliance standards for airworthiness. Software developers must design and build safety-critical systems that meet these standards and include safety-conscious redundancies. These standards include running a piece of software through a process known as software certification in which an external entity thoroughly reviews all aspects of the software in order to demonstrate the reliability and safety of the software.

One of the most common certification processes used worldwide to prove airworthiness of aircraft software systems is the DO-178C certification, in particular the DO-178C, Software Considerations in Airborne Systems and Equipment Certification. Countries such as the United States, Europe, and Canada utilize the DO-178C to certify aircraft software, among other certification methods and standards.

The DO-178C specifies different software levels, also referred to as Design Assurance Levels or Item Development Assurance Levels, that determine the effects of a failure on the system. The levels range from “A-E”, with “A” being “Catastrophic” failure condition. Aircraft engines fall into the “A” category due to the potential severity of accidents that may occur due to engine failure. Thus, the “A” category of the DO-178C is a very high standard that software developers must meet in order to prove airworthiness of their software.

Due to the scrutiny required of the “A” category of the DO-178C, certification of software in this category can be extremely time consuming. For example, the “A” category of the DO-178C includes 71 separate objectives that must be satisfied, with 30 of these objectives requiring “independence” (i.e. the verification of the software item that is the subject of the objective must be performed by a different person than the person who authored the software item). The extensive time required to certify such safety-critical software can have negative consequences. For example, a common approach to combating cyberattacks on software is to analyze the cyberattack and produce a new, different version of the software that can be deployed in place of the version that was attacked.

In some instances, a new version can be created that corrects or mitigates a flaw or vulnerability in the original software version, but this requires a detailed analysis of the attack and a change to the software (i.e. alter the software's design), all of which is time consuming, in particular in the context of an ongoing cyberattack. Alternatively, the binary/program flow and coding structure of the new version of the software may be different than the original version (i.e. only alter the software's implementation). The different flow and structure of the new version of the software makes it difficult for the attacker to create a revised/updated attack based on the new version, thus mitigating, preventing, or stopping the cyberattack.

A problem with deploying either of these new versions arises in the context of safety-critical software, because the new version of the software would have to undergo the same rigorous certification process as the original version. The extensive time required to certify the new version can delay the resolution of the attack, and can thus leave the system open to continued attack. This would be particularly problematic if it were completed after a time-consuming redesign of the software (i.e. the first type of new version described in the previous paragraph). The results of leaving the system open to such vulnerabilities can be catastrophic for applications such as aircraft engines.

The methods 100, 400 and system 200 described herein provide a means for reducing the time required to certify and deploy new versions of software, thus enabling much more efficient mitigation, prevention, and/or stoppage of cyberattacks. In particular, the time to respond to cyberattacks is reduced by rapidly certifying “functionally equivalent but structurally different” versions of the software in advance of the cyberattacks and the software version's subsequent deployment. The methods 100, 400 and system 200 according to the present disclosure achieve this reduction in time and improved mitigation and prevention of cyberattacks by automating the creation, verification and validation, and management of multiple images (i.e. versions) of software.

Illustratively, the method 100 according to the first aspect of the present disclosure includes operational steps that are executed at a developer level 102, an operational level 104, and an attacker level 106, as shown in FIG. 1. The operational steps may include creating multiple images of software (see operational steps 110, 11° F. in FIG. 1), automatically verifying and validating the software images (see operational steps 110C, 118 in FIG. 1), certifying the software images (see operational step 124 in FIG. 1), deploying a first image of the software (see operational step 126 in FIG. 1), detecting a cyberattack (see operational step 146 in FIG. 1), and deploying a second image of the software in response to detecting the cyberattack (see operational step 150 in FIG. 1).

The second image (and any subsequent images, such as a third image, a fourth image, and so on) is different than the first image. As such, the cyberattack may be mitigated, prevented, or stopped. Moreover, as described above, the different second image of the software makes it difficult for the attacker to create a revised/updated attack based on the second image. During this time that the attacker is developing updated software to attack the second image, weaknesses of the software images may be determined at the developer level 102, and an updated version of the software can be developed and deployed that resolves the weaknesses in the software, thus greatly reducing the chances of future attacks.

A person skilled in the art will understand that the “software” described herein with relation to aircraft engines may be any software, such as embedded software utilized by aircraft computers to managing real-time tasks for operating and maintaining aircraft engines. Such software includes safety-critical functionality related to engine operation and maintenance, and may be developed for any number of sizes of aircraft and usage scenarios, such as large passenger jets, defense aircraft, and the like. Such software may be initially designed and developed by aircraft manufacturers, software development companies and agencies, or software developer contractors and/or consultants.

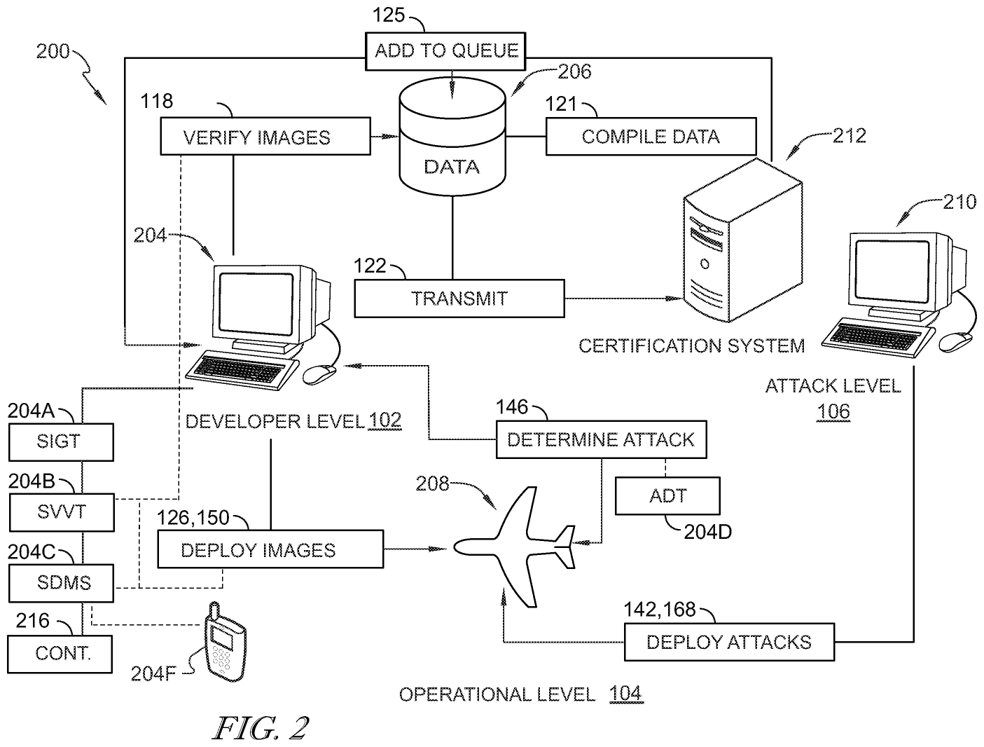

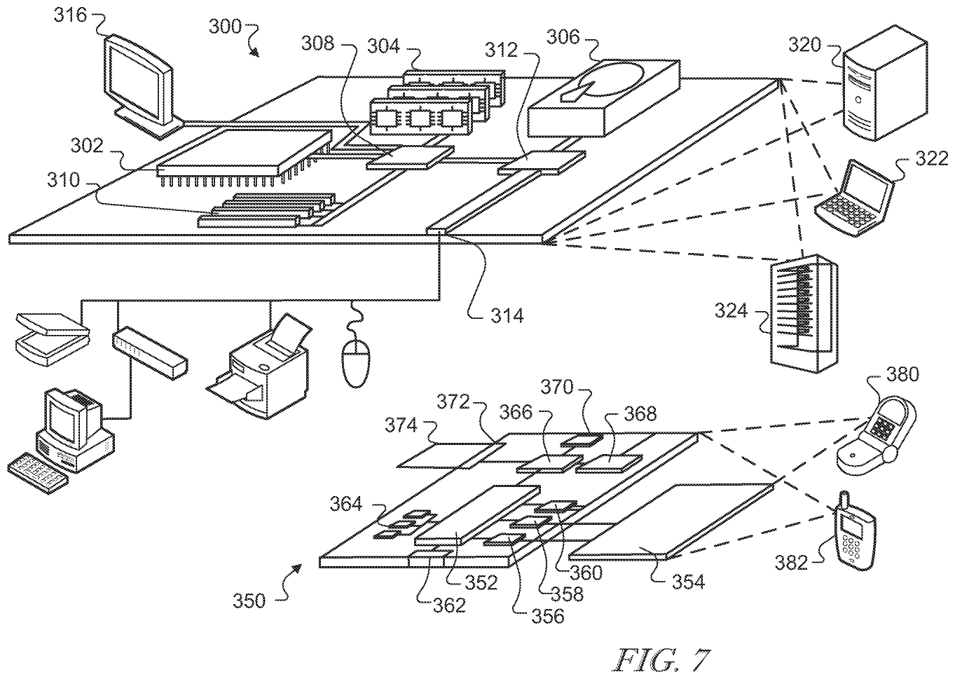

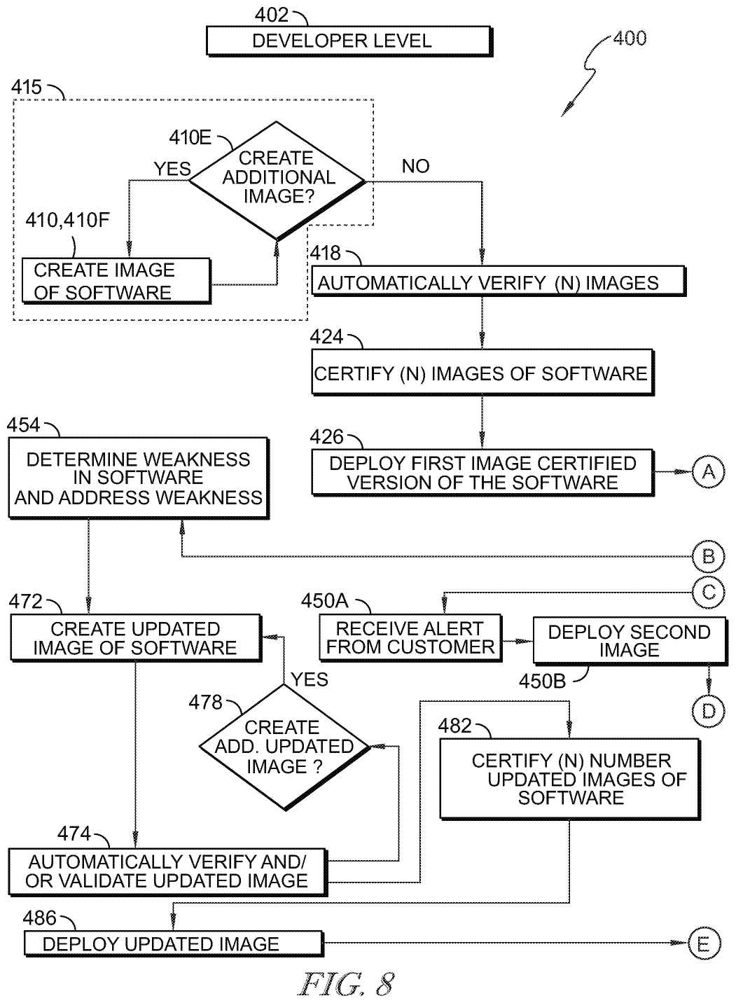

FIG. 2 shows a conceptual diagram of the system 200 configured to carry out the method 100 of FIG. 1, as well as the method 400 of FIG. 8. The system 200 can include various computing devices, servers, network communication devices, and the like, all of which will be described in greater detail below in relation to the operational steps carried out by each device. Illustratively, the system 200 may include a developer environment 204 at the developer level 102, a data store 206 at the developer level 102, an aircraft 208 at the operational level 104, an attacker developer environment 210 at the attack level 106, and an external certification system 212. A person skilled in the art will understand the various possible combinations of hardware, software, firmware, and the like that may constitute the various components of the system 200, although specifics of these components will be described in greater detail below with relation to FIG. 7.

The developer environment 204 may be a computing environment that enables creation, management, and deployment of the multiple images of the software. The developer environment 204 may be any collection of computing machinery and/or hardware, related software and firmware, data storage devices, memory devices, computer-readable non-transitory storage mediums, work stations, virtual machines, software applications, servers, network communication devices, and the like, each configured to interact with each other, either automatically or manually via developer input, to carry out the various operational steps of the methods 100, 400. The developer environment 204 may include stationary devices, mobile devices, wired devices, wireless devices, and any combination thereof.

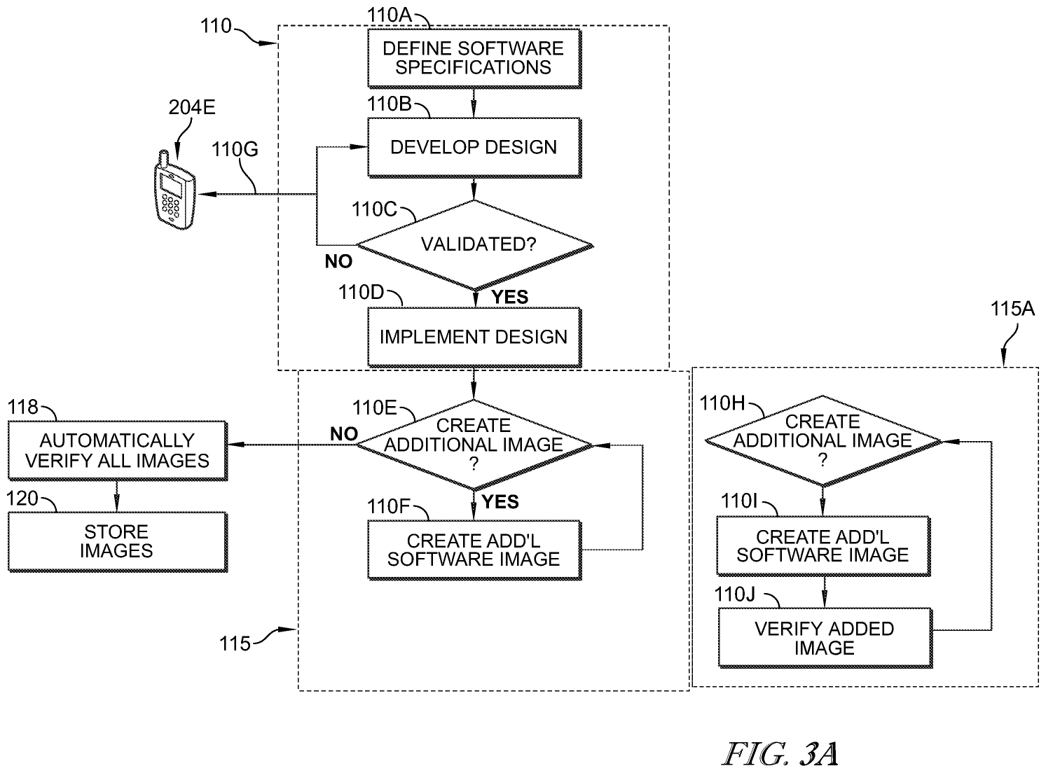

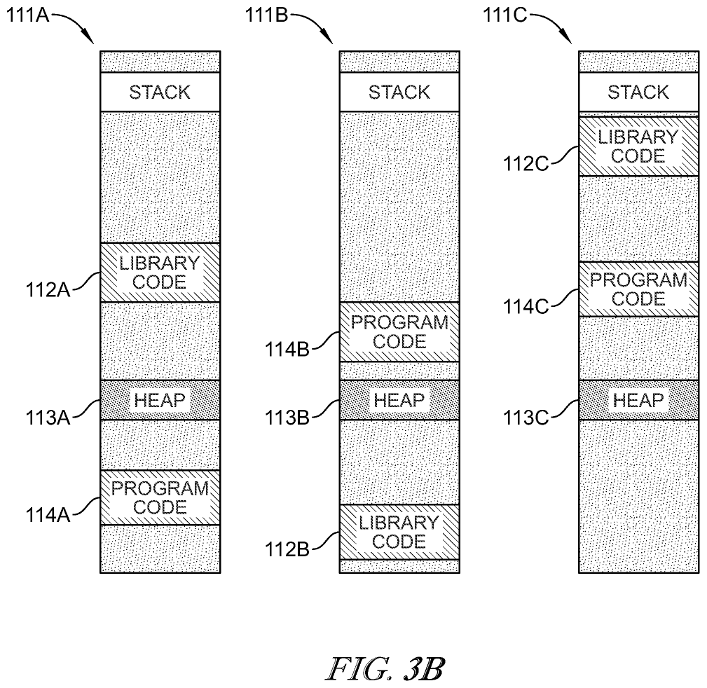

Illustratively, the method 100 includes a first operational step of creating a first image, or initial image, of the software 110, as shown in FIG. 1. This operational step 110 may include the initial design and creation of the software to be utilized in the aircraft engines 213, 214 of the aircraft 208 shown in FIG. 6, including the steps of determining the design requirements or end-user requirements, software development and design, and implementation (see FIG. 3A). In some embodiments, the first image of the software may be a first image created after the development and deployment of the software in an operating system of the engines 213, 214 at the operational level 104.

Illustratively, the operational step 110 of creating the first image of the software may include the sub-steps 110A, 110B, 110C, 110D shown in FIG. 3A. Specifically, an initial creation of the software is shown in sub-steps 110A, 110B, 110C, 110D, which may lead into an image creation loop 115 of the software development and image creation process. The image creation loop 115 may be carried out in conjunction with a verification step 118 of verifying the created images of the software.

The verification and validation process for software is well-known process in software engineering used to confirm that the software functions as intended and meets all requirements. In particular, the validation of software checks whether a design specification of software meets a customer or user's requirements, while verification checks whether the software meets the design specification.

As can be seen in FIG. 3A, the operational step 110 of creating a first image of the software may include a first sub-step 110A of defining software specifications, which may include receiving initial set of specifications and/or requirements from a customer or end-user. Defining the software specifications 110A may include setting requirement metrics and target values for the designed software to meet. Subsequent to defining the software specifications 110A, a sub-step 110B of developing and designing the software in order to meet the specifications set out in sub-step 110A.

After a suitable design is achieved, a third sub-step 110C of validating the developed design is carried out. At this point, testing may be executed at sub-step 110C, the results of which are compared to the requirement metrics and target values in order to determine whether the implemented design solution meets all requirement metrics and target values of the design specification of sub-step 110A (i.e. “validated”). In some embodiments, a software verification and validation tool (“SVVT”) 204B is configured to, at least partially or fully autonomously or automatically, validate the design. In other embodiments, the software verification and validation tool (“SVVT”) 204B is configured to assist with the validation process (e.g., by creating and executing certain tests and checks for validation purposes), while other portions of the validation process are carried out manually by a user.

Validation of the software images may include checks and tests as to whether a design specification of software meets a customer or user's requirements. In some embodiments, at sub-step 110C, the software verification and validation tool 204B may be configured to simulate a customer or end-user environment in order to automatically test each verified software image within, or may be configured to test each image on real-world testing machines and environments. These automatic tests may be set up similarly as the verification tests described below, in particular to include the automatic creation and execution of test scenarios and test scripts corresponding to the specific image being validated. Such tests may include unit testing, integration testing, system testing, and/or acceptance testing.

A person of skill in the art will understand that these tests are merely exemplary, and that fewer or additional tests may be automatically carried out during the validation process. In some embodiments, the validation of an image may begin after the verification of the images such that the automatic validation runs simultaneously with the automatic creation and verification of the images. In some embodiments, the software verification and validation tool 204B may be configured to optionally send a signal or message 110G to a user device 204E indicative of the design not meeting the specifications so as to alert a user or developer that additional input may be required to remedy the situation.

As shown in FIG. 3A, if the specifications have not been met during the validation sub-step 110C, the process 110 may repeat at sub-step 110B in order to refine the design. After it is confirmed that the design of the software has been validated, operation step 110 may proceed to sub-step 110D of implementing the design. The process 110 may proceed to sub-step 110E, which asks whether additional images should be created. If so, additional images are created at sub-step 110F, and an automatic verification process is carried out during the creation of additional images or after all images have been created, which will be described in greater detail below.

Illustratively, the sub-step 110F of creating the additional images of the initial software image or version may be carried out by a software image generation tool (“SIGT”) 204A, which may be part of the developer environment 204 as shown in FIG. 2. A person skilled in the art will be familiar with the standard process of creating multiple images (i.e. versions) of a piece of software or software system for subsequent deployment and application, and as such, the term “images” will not be described further herein. The multiple images may be referred to as “(N) images” or “(N) number of images” in the drawings. A person skilled in the art will also understand that the creation of the multiple images, including the creation of the initial, first image, may occur before or after a cyberattack is deployed on the operating system of the engines 213, 214.

In some embodiments, the software image generation tool 204A is a software suite, module or modules, or tool configured to automatically create multiple images of the software, and in particular, functionally equivalent but structurally different (“FESD”) images of the software (i.e. the different “first image” and “second image” of software described above). As discussed above, the differing structures of the multiple images make it difficult for an attacker to create a revised/updated attack based on the newly deployed image, thus mitigating, preventing, or stopping the cyberattack.

“Functionally equivalent but structurally different” means that the binary/program flow and coding structure of the multiple images of the software differ, while each image is configured to produce the same output based on the same input. In other words, although each image includes different binary/program flow and coding structure, each image is configured to utilize an input and produce the same output as all other images. The software image generation tool 204A is configured to utilize the source code of the software, provided by a developer, and reorganize the code layout (i.e. binary/program flow and coding structure) of the software in order to create any number of images of the software.

In some embodiments, functionally equivalent but structurally different software images may be achieved utilizing a “binary stirring”. When a compiler converts high level software instructions (i.e. “for”, “while”, “if”, “then”) into the tiny individual operations a microprocessor can actually implement (i.e. instructions such as add two registers, store a register to a memory location, jump to a new instruction location) it often follows a very simple template for each high level instruction. However, compiler designers realize that these templates can be very inefficient, repeating operations that have already happened with no chance to change, check conditions that must be true or false, or, importantly, perform operations in an order that will execute much more slowly than necessary. To improve compiler output, an optimization step is often included where the compiler checks for inefficient operations and then rearranges the instructions to eliminate unnecessary steps and change the order of operations so that the processor's resources will be used more efficiently. An important feature of this optimization step is that the output behavior must not change except in how quickly it is accomplished.

“Binary stirring” is very similar to compiler optimization in that it analyzes the low level instructions in the software executable and rearranges them to produce the same results but implementing them in a unique order rather than specifically to increase speed. Therefore, a binary stirred executable should always be “functionally equivalent but structurally different” from the original. Because there are many equivalent orders of instructions, it is possible to create very large numbers of unique FESD versions of the same software.

As a non-limiting example, and solely for the purpose of illustrating what may constitute “functionally equivalent but structurally different,” FIG. 3B shows three possible code layouts 111A, 111B, 111C (also referred to as software “stacks” in FIG. 3B) of three differing images of a single piece of software.

The first image of the software may include a first code level layout 111A and be configured to output a first system level output based on a first system level input, as shown in FIG. 3B. The first code level layout 111A can include library code 112A at the top-level of a hierarchy of the stack 111A, a memory heap 113A at the mid-level of the hierarchy of the stack 111A, and program code 114A at the bottom-level of the hierarchy of the stack 111A.

The second image of the software may include a second code level layout 111B different than the first code level layout 111A and be configured to output a second system level output equal to the first system level output based on a second system level input equal to the first system level input, as shown in FIG. 3B. The second code level layout 111B can include program code 114B at the top-level of a hierarchy of the stack 111B, a memory heap 113B at the mid-level of the hierarchy of the stack 111B, and library code 112B at the bottom-level of the hierarchy of the stack 111B.

The third image of the software may include a third code level layout 111C different than the first and second code level layouts 111A, 111B and be configured to output a third system level output equal to the first and second system level outputs based on a third system level input equal to the first and second system level inputs, as shown in FIG. 3B. The third code level layout 111C can include library code 112C at the top-level of a hierarchy of the stack 111C, program code 114C at the mid-level of the hierarchy of the stack 111C, and a memory heap 113C at the bottom-level of the hierarchy of the stack 111C.

A person skilled in the art will understand that, although the example shown in FIG. 3B shows the structure of the software stack being modified between versions, other known methods of providing functionally equivalent but structurally different images may be utilized, such as reorganizing the code of each of the library code, program code, etc. on a binary level, address space layout randomization (“ASLR”), the “binary stirring” methods described above, and similar reorganization methods.

As shown in FIGS. 1 and 3A, after the creation of the initial or first software image is sub-steps 110A, 110B, 110C, 110D, the method 100 may proceed to the decision step 110E regarding whether additional images should be created. In some embodiments, a developer may manually provide input as to whether an additional image should be created, while in other embodiments, there may be a preset, predetermined number of images such that the software image generation tool 204A automatically creates the predetermined number of images. As will be described in greater detail below with regard to operational step 125 (loading certified images into a queue), the operational step 110 may utilize the image creation loop 115 or the image creation loop 115A shown in FIG. 3A in order to create the additional software images.

As can be seen in FIG. 3A in the image creation loop 115, after each image of the software is created at sub-step 110F, the process moves back to sub-step 110E, which asks whether additional images should be created. If so, additional images are created at sub-step 110F. After all images have been created, all images can be at least partially or fully automatically verified at operational step 118. As can also be seen in FIG. 3A, in some embodiments, an alternative image creation loop 115A may be utilized in which each newly created image (at sub-step 110I) is at least partially or fully automatically verified at sub-step 110J before the loop 115A begins again with asking whether additional images should be created at sub-step 110H.

It may be beneficial in some scenarios to use one of the image creation loop 115, 115A as opposed to the other image creation loop 115, 115A. As will be described in greater detail below, after an image has been deployed at operational step 126 (and thus removed from the queue of images ready for deployment), a single new image may need to be added to the queue such that the same number of images are once again in the queue. In this scenario, the alternative image creation loop 115A may be utilized such that the newly created image can be immediately verified.

After it is determined that the total number of desired images of the software have been created (i.e. the answer to “CREATE ADDITIONAL IMAGE?” 110E is “NO”), the method 100 proceeds to operational step 118 of automatically verifying the created images of the software, as shown in FIGS. 1 and 3A.

The automation of the verification process of operational step 118 may be executed by the software verification and validation tool 204B. This automatic verification process may include the automatic creation and execution of test scenarios and test scripts corresponding to the specific image being verified. The test scenarios may include various simulations and evaluations of the intended and implemented functionality of the software image, and may automatically compare the desired requirement metrics and target values of the design specifications of the software to the test results of the specific image in order to ensure that the specifications are met. In some embodiments, the verification process may be fully autonomous, while in other embodiments, may be only partially automated while other processes are carried out manually by a user. In some embodiments, the verification process may be entirely manual.

Because each of the software images are functionally equivalent but structurally different, the output of the images should all be the same. Thus, the same test scenarios, simulations, evaluations, and the like of the verification process in operational step 118 may be the same for all software images. Accordingly, a significant amount of time is saved in the creation and execution of the verification and validation processes of the multiple images, thus ultimately reducing engineering and development costs. As opposed to creating each image separately from the starting point of, for example sub-step 110A or 110B, all of the images can be verified before moving on to certification, thus greatly reducing the total time of the verification and validation process. The time saving allows for the verification and validation data of the multiple images to be quickly and efficiently stored for later compiling and transmitting (operational steps 121 and 122) to an external certification entity (“certifier”) for certification. The process essentially achieves diverse redundancy by maximizing the efficiency of the verification and validation processes utilizing images that are each verified the same way.

If it is determined than any of the images cannot be verified at operational step 118, the image may be removed from the group of images that are being evaluated for verification, or may be returned to the developer environment 204 for remedial action by a developer or engineer. After the automatic verification step 118 is carried out, the method 100 may move to operational step 120, in which a software deployment management system (“SDMS”) 204C (also referred to as a “subsystem”) may store the verified and validated images for later certification, queueing, and deployment at the operational level 104 (i.e. the engines 213, 214 of the aircraft 208), as will be described in greater detail below.

In some embodiments, the software verification and validation tool 204B itself may be verified and validated utilizing similar methods as described above. In particular, initial software specifications of the tool 204B may be defined at sub-step 110A, and the design of the tool 204B may be executed at sub-step 110B and validated at sub-step 110C. The design of the tool 204B may then be implemented at sub-step 110D and, finally, verified at operational step 118.

After all of the created images are verified and validated (confirmed at step 118 by the software image generation tool 204A or the software verification and validation tool 204B), the software deployment management system 204C temporarily stores the verified and validated images 120 in a data store 206 until the images can be sent to an external certifier for certification, as shown in FIGS. 1 and 2.

As discussed above, software certification is a process in which an external entity (“certification system 212” in FIG. 2) thoroughly reviews all aspects of a piece of software in order to demonstrate the reliability and safety of the software. Certification of software for aircraft engines can be particularly time consuming due to the high levels of scrutiny required of safety-critical systems.

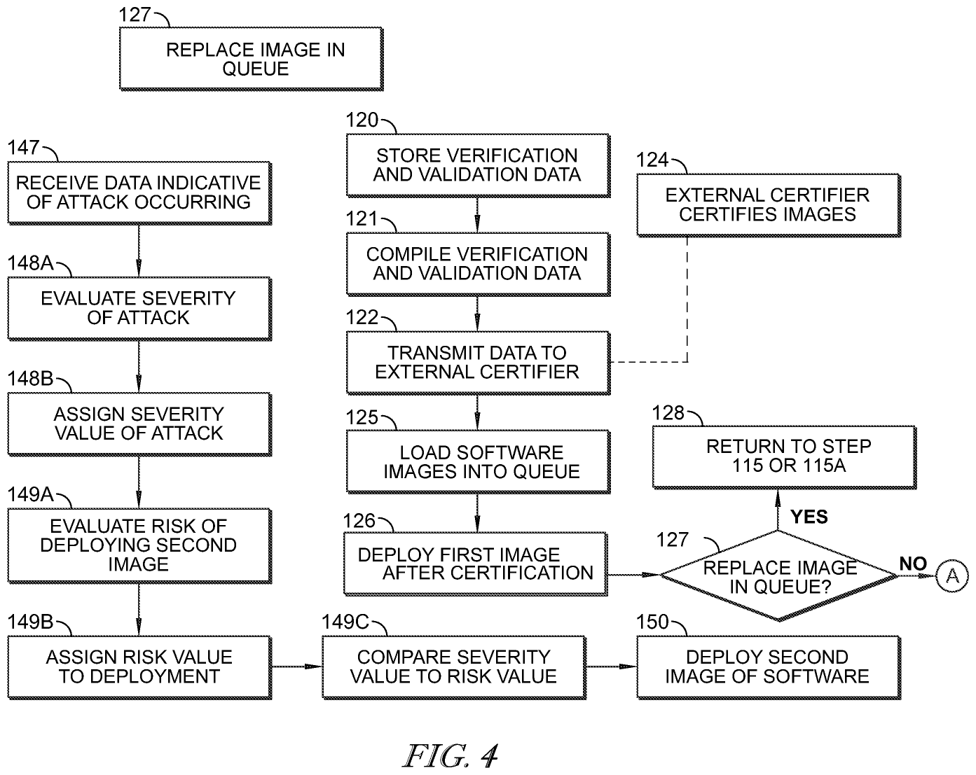

In order to significantly reduce the time required to certify the exemplary aircraft engine software and its multiple images described herein, the software deployment management system 204C is configured to compile (operational step 121) verification and validation data associated with each of the created software images for subsequent transmittal to an external certification system 212, as shown in FIG. 4. Specifically, the verification and validation data are indicative of the confirmed verification and validation of all of the created software images, and can include data showing test and simulation results of the verification and validation process.

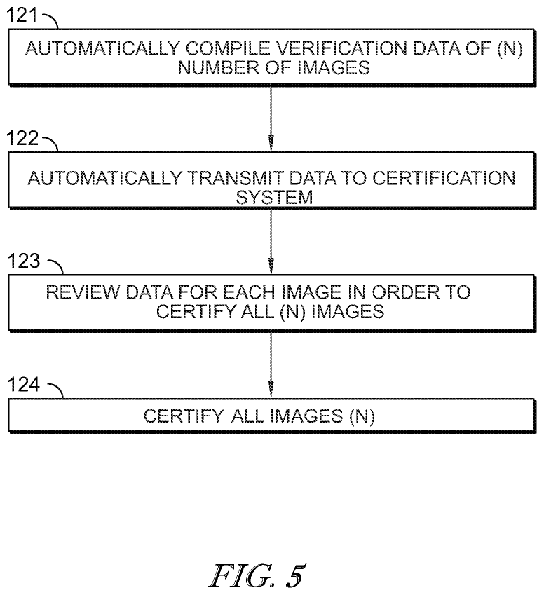

Once the verification and validation data are compiled at operational step 121, the software deployment management system 204C is configured to transmit the compiled data, at operational step 122, to the external certification system 212 (also referred to as the “certifier”). In some embodiments, the steps of storing, 120, compiling 121, and transmitting 122 may be carried out automatically by the software deployment management system 204C, as shown in FIG. 5. For example, the software deployment management operational 204C may be configured to automatically store, 120, compile 121, and transmit 122 the verification and validation data in response to receiving a signal or message from the software image generation tool 204A or the software verification and validation tool 204B indicative that the software image generation tool 204A or the software verification and validation tool 204B has confirmed that all created images of the software are valid (operational step 118).

The certifier may be any external group or entity organized for the purpose of evaluating the software images to ensure that they comply with the appropriate standards of functionality (e.g. the “DO-178C certification” standards described above). In some embodiments, the certification process may include, but is not limited to, reviewing data (i.e. verification and validation data) for each image in order to certify each image (operational step 123), and confirming that all images are certified (operational step 124), as shown in FIG. 5. Operational step 123 and operational step 124 may occur after the automatic execution of operational step 121 and operational step 122.

By transmitting 122 the compiled verification and validation data all at once in a packaged, easily digestible format, the certifier can certify the images in much less time than if the software images were transmitted separately to the certifier (i.e. a first image is sent and then certified, then a subsequent image is sent and then certified, and so on). In this way, the multiple software images can be quickly certified and ready for rapid deployment to combat cyberattacks on the operating system of the engines 213, 214 at the operational level 104.

As can be seen in detail in FIG. 4, once the software images are certified or simultaneously while the software images are being certified by the certification entity, the software deployment management system 204C is configured to load the software images into a queue at operational step 125. The queue of images may be included in any storage medium (i.e. data store 206). The queue may include all of the images that had been created, verified, and validated during operational steps 110-118, as described above, or may include only those images that had been created that are necessary for a particular application.

In some examples, the number of images that are stored in the queue are dependent on the severity of the detected cyberattack and a predicted time that the attack will take to execute, as described in detail below with regard to operational step 148A. As a non-limiting example, if the time to execute the attack is relatively long, a smaller number of images may be stored in the queue. If the time to execute the attack is relatively short, a larger number of images may be stored in the queue.

In some embodiments, the number of queued images can be determined by an analysis of the expected types of threats and the expected time required to analyze the attack and mitigate the exploited vulnerability and then certify and deploy the new software. The marginal cost of certifying multiple images versus the value at risk in operating or not operating the affected aircraft would also influence the decision. As a non-limiting example, if the expected threat being addressed was external and required high effort to acquire and analyze the software and formulate an attack, it might be concluded that a new attack would take two or so months to produce in response to deployment of a new FESD image. If it were believed that the aircraft engine manufacturer's response to analyze the attack, redesign the software, certify the software, and deploy the software would take six months, then at least three FESD images should be provided in the queue. However, if it were expected that an insider threat that could obtain the new software quickly and reformulate the attack in one month and the engine manufacturer's response would take a year, then at least 12 FESD images should be provided in the queue. A person skilled in the art will understand that these are merely exemplary scenarios.

In some embodiments, the software deployment management system 204C may be configured to manage the queue so as to maintain a constant number of images in the queue. For example, if an image or images are deployed (operational step 126), the method 100 may move to operational step 127 at which it is asked whether the deployed image or images need to be replaced in the queue. If the deployed image or images need replaced, the method 100 may proceed to operational step 128, which returns the method 100 to either image creation loop 115 or the alternative image creation loop 115A. As described above, if a single image needs replaced, it may be beneficial to proceed to the alternative image creation loop 115A at which a single image is created and immediately verified. If the image does not need to be replaced in the queue, the method 100 may proceed to operational step 130. In some embodiments, two or more images may replace the single deployed image so as to remain ahead of potential demand in case the next cyberattack arrived sooner than expected.

In some embodiments, the software deployment management system 204C may be configured to dynamically determine the number of images that should be stored in the queue. As a non-limiting example, the number of images that remain in the queue may change if the data received regarding the attack (operational step 147) changes over time. Accordingly, the software deployment management system 204C may be configured to dynamically adjust the number of images in the queue based on changes in the detected cyberattack.

In some scenarios, the software deployment management system 204C may be configured to remove all images from the queue such that brand new images may be created and loaded into the queue (i.e. the queue is “reset”). This may be useful when the initial specifications (sub-step 110A) are being updated, and thus the current images are no longer relevant to the updated specifications. In some embodiments, the characteristics of the cyberattack and the corresponding required response may require updating of the initial specifications, thus requiring removal of all current images in the queue. Other properties such as a current vulnerability of the operating system, engine state, engine efficiency, and the like may be factors in resetting of the queue.

Referring back to the deployment of one of the images, the software deployment management system 204C is configured to remove at least one image (“first image”) from the queue and deploy (operational step 126) the first image of the software to the operating system of the engines 213, 214 at the operational level 104, and the first image may begin operating (operational step 130) at the operational level 104.

Upon the beginning of operation 130 of the first image, an attacker utilizing the attacker developer environment 210 may begin development of a cyberattack on the first image at the attacker level 106, as also shown in FIGS. 1, 2, and 4. Specifically, at the attacker level 106, the attacker may determine attributes of the first image 134, develop a first attack software 138 based on the attributes of the first image of the software, and then deploy the first attack software 142 on the first image of the software.

An attack detection tool 204D may be operated at the operational level 104 as part of the operating system of the engines 213, 214, or at the developer level 102 in the developer environment 204 which is operably and communicatively connected to the operating system of the engines 213, 214. The attack detection tool 204D is configured to either preemptively or in real-time determine that a cyberattack has been deployed on the first image of the software running on the operating system of the engines 213, 214, as shown in FIGS. 1 and 2.

Once the cyberattack is detected by the attack detection tool 204D, the attack detection tool 204D may transmit data indicative of the cyberattack to the software deployment management system 204C, which receives this data at step 147, as shown in FIG. 4. The software deployment management system 204C may include a control logic that then automatically carries out a series of steps in order to determine whether to remove a second image of the software from the queue and deploy the second image to the operating system of the engines 213, 214 to replace the currently operating first image so as to combat the cyberattack.

Specifically, the method 100 may proceed to step 148A in which the control logic of the software deployment management system 204C automatically evaluates the severity of the detected cyberattack in order to provide context as to whether the second image should be deployed to combat the cyberattack. Specifically, the control logic of the software deployment management system 204C is configured to evaluate data regarding the cyberattack received from the attack detection tool 204D to determine the severity of the cyberattack. In some embodiments, the software deployment management system 204C may provide a summarization or detailed account of the cyberattack for user review and assessment.

The data received from the attack detection tool 204D may include severity factors that can include, but are not limited to, a number of subsystems of the first image of the software that would be affected by the cyberattack and related information, historical data regarding similar cyberattacks of this nature on the operating system of the engines 213, 214, the vulnerability of the operating system 213, 214 at the time of the cyberattack, downtime that would be caused by the cyberattack, potential level of failure of the engines 213, 214 that may be caused by the cyberattack, and similar data. A person skilled in the art will understand that this list is not exhaustive, and that other severity factors may be taken into consideration by the control logic of the software deployment management system 204C in evaluating the severity of the attack.

After evaluating the severity of the cyberattack, the control logic of the software deployment management system 204C may proceed to automatically assign a severity value to the cyberattack (step 148B), as shown in FIG. 4. In some embodiments, the severity value may be a binary number in a specified, predetermined range of numbers, such as, for example, 0 to 5. A person skilled in the art will understand that any range of numerical values may be used as a scale indicative of the severity of the cyberattack.

The control logic of the software deployment management tool system 204C is configured to automatically assign the severity value based on different aspects of the data received from the attack detection tool 204D, including but not limited to, how many of the severity factors described above are present in the cyberattack. As a non-limiting example, if three out of five factors are present in the cyberattack, the control logic of the software deployment management system 204C is configured to assign a severity value of “3” on a scale of 0 to 5.

Additionally, in some embodiments, the control logic of the software deployment management system 204C may be configured to automatically assign a weighting to the severity factors such that some severity factors raise the severity value of the cyberattack more than others. Specifically, severity factors that have a higher chance of causing serious or catastrophic failure of the first image of the software, of the operating system of the engines 213, 214, and/or of the engines 213, 214 themselves will be weighted greater than other severity factors. By way of a non-limiting example, if the cyberattack only presents a severity factor regarding a high potential of failure of the engines 213, 214, because the control logic of the software deployment management system 204C has weighted this severity factor higher than others, the severity value may still be a “3” or higher on a scale of 0 to 5, even though only a single severity factor is present in the cyberattack.

After assigning 148B the severity value of the cyberattack, the control logic of the software deployment management system 204C proceeds to automatically evaluating the risk of deploying a second image of the software in place of the first image (step 149A), as shown in FIG. 4. Deployment and installation of software is typically a high-scrutinized process, where many factors must be considered before a new image or version of software can be securely deployed to an operating system. This time-consuming process can sometimes last too long in situations required urgent remedy, such as when a cyberattack is being deployed. The risk of deploying a new version or image must be considered against the risk of waiting too long to deploy the new version (by following all usual procedures required to deploy the new version), which might allow the cyberattack to irreversible progress. As such, the control logic of the software deployment management system 204C is configured to evaluate a current state of the operating system of the engines 213, 214 and the aircraft 208 in order to determine whether to deploy the second image.

The software deployment management system 204C may be operably and communicatively connected to the operating system of the engines 213, 214 and the aircraft 208 in order to evaluate risk factors of deploying the second image. Such risk factors can include, but are not limited to, whether the operating system is in a state ready for updating to the second image, whether any security protocols could potentially be violated by updating to the second image, whether any geographical restrictions apply to the potential update to the second image, whether performing the update will pose any security risks during the update process, and similar factors. A person skilled in the art will understand that this list is not exhaustive, and that other risk factors may be taken into consideration by the control logic of the software deployment management system 204C in evaluating the risk of deploying the second image of the software.

After evaluating the risk of deploying the second version, the control logic of the software deployment management system 204C may proceed to automatically assign a risk value to deploying the second version (step 149B), as shown in FIG. 4. This assignment of risk values may be similar to the assignment of the severity values described above. Specifically, in some embodiments, the risk value may be a binary number in a specified, predetermined range of numbers, such as, for example, 0 to 5. A person skilled in the art will understand that any range of numerical values may be used as a scale indicative of the risk of deploying the second image.

The control logic of the software deployment management system 204C is configured to automatically assign the risk value based on different aspects of the risk evaluation, including but not limited to, how many of the risk factors described above are present. As a non-limiting example, if three out of five factors are present, the control logic of the software deployment management system 204C is configured to assign a risk value of “3” on a scale of 0 to 5.

Additionally, in some embodiments, the control logic of the software deployment management system 204C may be configured to automatically assign a weighting to the risk factors such that some risk factors raise the risk value of deploying the second image more than others. Specifically, risk factors that have a higher chance of causing serious or catastrophic failure of the first image of the software, of the operating system of the engines 213, 214, and/or of the engines 213, 214 themselves will be weighted greater than other risk factors. By way of a non-limiting example, if only a risk factor regarding a high potential of failure of the engines 213, 214 is present, because the control logic of the software deployment management system 204C has weighted this risk factor higher than others, the risk value may still be a “3” or higher on a scale of 0 to 5, even though only a single risk factor is present.

After the severity value is assigned (step 148B) and the risk value is assigned (step 149B), the control logic of the software deployment management system 204C compares the severity value to the risk value at step 149C, as shown in FIG. 4. Specifically, if the severity value is greater than the risk value, the software deployment management system 204C deploys the second image of the software to the operating system of the engines 213, 214 (step 150), as shown in FIGS. 1, 2, and 4.

Once the second image is deployed and is operating on the operating system of the engines 213, 214 (step 158), the attacker at the attacker level 106 may recognize that the initial first attack software is no longer effective against the second image of the software, and thus may revert to determining the attributes of the second image (step 162), developing a second attack software (step 164), and deploying the second attack software on the second image (step 168), as shown in FIG. 1. It will take considerable time for the attacker to both recognize that a new image has been deployed and to develop a new attack (second attack). As a result, the developers of the software are afforded significant time, while the second image is running and the attacker is developing the second attack, to evaluate the weaknesses in the software as a whole and develop an updated image of the software that addresses these weaknesses. This updated image would be a significant security improvement with respect to the initial cyberattacks as compared to the first, second, and any additional images of the initial software version.

Specifically, at any time before, during, or after the deployment of the second image and potentially while the second image is running on the operating system of the engines 213, 214, the method 100 may proceed to step 154 of determining weaknesses in the software with respect to the particular cyberattacks that have been deployed and potential future cyberattacks, as shown in FIG. 1. After the developers determine how best to combat future cyberattacks, an updated image of the software may be created at step 172. The updated image will address the current or future cyberattacks, and enough time is afforded to the development of this updated version via the delay in subsequent attacks caused by the deployment of the second image of the software.

Similar to the automated creation of the images, the automated verification and validation of the software images, and the certification of the software images described above with respect to the first and second images, the updated image may also undergo the same process in order to create multiple images of the updated image and have them verified, validated, and certified in a time efficient manner.

Specifically, as shown in FIG. 1, the updated image may be automatically verified 174, and then additional images of the updated image may subsequently be created 178 and verified 174, similar to the first and second images above (i.e. operational steps 110-118). Also similar to the images above, the additional images of the updated image may subsequently be automatically stored (similar to the storing 120 of the verified and validated first and second images in a data store 206, described above), and then compiled (similar to the compiling step 121 above) and transmitted to the certifier for certification (step 182). Once the updated image(s) are certified, they can be deployed (step 186) to the operating system of the engines 213, 214 in order to provide greatly improved security to the operating system from future cyberattacks. The updated image may continue to operate on the operating system (step 190) until additional cyberattacks are deployed, at which point the method 100 may be carried out again to combat the new cyberattack.

In some embodiments, the components of the system 200, including all components of the developer environment 204 at the developer level 102 and the aircraft 208 at the operational level 104, may be operably and communicatively connected to each other, either via a wired or wireless connection. Specifically, components such as the software image generation tool 204A, the software verification and validation tool 204B, the software deployment management system 204C, the attack detection tool 204D, the data store 206, the aircraft 208, and the operating system of the engines 213, 214 can all be connected on a network such that each component can communicate and transfer data to the other components.

In some embodiments, the software image generation tool 204A may be configured to send signals or messages indicative of the status of creation of the multiple images to the software verification and validation tool 204B such that the software verification and validation tool 204B can take over the method 100 and begin the automatic verification and validation process. Similarly, the software verification and validation tool 204B may be configured to send signals or messages indicative that the software has been verified, validated, and certified to the software deployment management system 204C to instruct the software deployment management system 204C that it is appropriate to being the evaluation process of whether to deploy the second image of the software. In some embodiments, the attack detection tool 204D may be configured to send signals or messages indicative that a cyberattack has begun to the software image generation tool 204A to instruct the software image generation tool 204A to begin the method 100 or to the software deployment management system 204C to begin evaluation and deployment of additional images.

In some embodiments, a general-purpose controller 216 or controllers 216 may be operably and communicatively connected, via a wired or wireless connection, to every component of the system 200, as shown in FIG. 2. The controller 216 may include a control logic configured to manage and instruct each component to carry out the method 100 described above, in particular at least the software image generation tool 204A, the software verification and validation tool 204B, the software deployment management system 204C, the attack detection tool 204D, the user device 204E, the customer user device 204F (described below), the data store 206, the aircraft 208, and the operating system of the engines 213, 214.

In some embodiments, each engine 213, 214 may include its own controller 216 configured to carry out the method 100 so as to provide redundancy to the system 200. Similarly, in some embodiments, each of the software image generation tool 204A, the software verification and validation tool 204B, the software deployment management system 204C, the attack detection tool 204D, the user device 204E, the customer user device 204F (described below), the data store 206, the aircraft 208 can include its own controller 216. As described with respect to FIG. 7, the controller 216 may be a computing device or collection of devices including a processor or processors, and non-transitory computer readable storage mediums, configured to carry out instructions for the components of the system 200 to execute the method 100.

FIG. 7 shows an example of a computing device 300 and an example of a mobile computing device that can be used to implement the techniques described herein, in particular the methods 100, 400. The computing device 300 and the mobile computing device may be utilized as, for example, the software image generation tool 204A, the software verification and validation tool 204B, the software deployment management system 204C, the attack detection tool 204D, the user device 204E, the customer user device 204F, the data store 206, the aircraft 208, the operating system of the engines 213, 214, and/or the controller 216.

The computing device 300 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and can be mounted on a common motherboard or in other manners as appropriate.

The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 304 stores information within the computing device 300. In some implementations, the memory 304 is a volatile memory unit or units. In some implementations, the memory 304 is a non-volatile memory unit or units. The memory 304 can also be another form of computer-readable medium, such as a magnetic or optical disk.

The storage device 306 is capable of providing mass storage for the computing device 300. In some implementations, the storage device 306 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 304, the storage device 306, or memory on the processor 302.

The high-speed interface 308 manages bandwidth-intensive operations for the computing device 300, while the low-speed interface 312 manages lower bandwidth-intensive operations. Such allocation of functions is exemplary only. In some implementations, the high-speed interface 308 is coupled to the memory 304, the display 316 (e.g., through a graphics processor or accelerator), and to the high-speed expansion ports 310, which can accept various expansion cards (not shown). In an exemplary implementation, the low-speed interface 312 is coupled to the storage device 306 and the low-speed expansion port 314. The low-speed expansion port 314, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter. The components of the system 200 described above may be configured to communicate with each other via methods such as these.

The computing device 300 can be implemented in a number of different forms, as shown in the figure. For example, it can be implemented as a standard server 320, or multiple times in a group of such servers. In addition, it can be implemented in a personal computer such as a laptop computer 322. It can also be implemented as part of a rack server system 324. Alternatively, components from the computing device 300 can be combined with other components in a mobile device (not shown), such as a mobile computing device 350. Each of such devices can contain one or more of the computing device 300 and the mobile computing device 350, and an entire system can be made up of multiple computing devices communicating with each other.

The mobile computing device 350 includes a processor 352, a memory 364, an input/output device such as a display 354, a communication interface 366, and a transceiver 368, among other components. The mobile computing device 350 can also be provided with a storage device, such as a micro-drive or other device, to provide additional storage. Each of the processor 352, the memory 364, the display 354, the communication interface 366, and the transceiver 368, are interconnected using various buses, and several of the components can be mounted on a common motherboard or in other manners as appropriate.

The processor 352 can execute instructions within the mobile computing device 350, including instructions stored in the memory 364. The processor 352 can be implemented as a chipset of chips that include separate and multiple analog and digital processors. The processor 352 can provide, for example, for coordination of the other components of the mobile computing device 350, such as control of user interfaces, applications run by the mobile computing device 350, and wireless communication by the mobile computing device 350.

The processor 352 can communicate with a user through a control interface 358 and a display interface 356 coupled to the display 354. The display 354 can be, for example, a TFT (Thin-Film-Transistor Liquid Crystal Display) display or an OLED (Organic Light Emitting Diode) display, or other appropriate display technology. The display interface 356 can comprise appropriate circuitry for driving the display 354 to present graphical and other information to a user. The control interface 358 can receive commands from a user and convert them for submission to the processor 352. In addition, an external interface 362 can provide communication with the processor 352, so as to enable near area communication of the mobile computing device 350 with other devices. The external interface 362 can provide, for example, for wired communication in some implementations, or for wireless communication in other implementations, and multiple interfaces can also be used.

The memory 364 stores information within the mobile computing device 350. The memory 364 can be implemented as one or more of a computer-readable medium or media, a volatile memory unit or units, or a non-volatile memory unit or units. An expansion memory 374 can also be provided and connected to the mobile computing device 350 through an expansion interface 372, which can include, for example, a SIMM (Single In Line Memory Module) card interface. The expansion memory 374 can provide extra storage space for the mobile computing device 350, or can also store applications or other information for the mobile computing device 350.

Specifically, the expansion memory 374 can include instructions to carry out or supplement the processes described above, and can include secure information also. Thus, for example, the expansion memory 374 can be provide as a security module for the mobile computing device 350, and can be programmed with instructions that permit secure use of the mobile computing device 350. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 364, the expansion memory 374, or memory on the processor 352. In some implementations, the computer program product can be received in a propagated signal, for example, over the transceiver 368 or the external interface 362.

The mobile computing device 350 can communicate wirelessly through the communication interface 366, which can include digital signal processing circuitry where necessary. The communication interface 366 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 368 using a radio-frequency. In addition, short-range communication can occur, such as using a Bluetooth, WiFi, or other such transceiver (not shown). In addition, a GPS (Global Positioning System) receiver module 370 can provide additional navigation- and location-related wireless data to the mobile computing device 350, which can be used as appropriate by applications running on the mobile computing device 350.

The mobile computing device 350 can also communicate audibly using an audio codec 360, which can receive spoken information from a user and convert it to usable digital information. The audio codec 360 can likewise generate audible sound for a user, such as through a speaker, e.g., in a handset of the mobile computing device 350. Such sound can include sound from voice telephone calls, can include recorded sound (e.g., voice messages, music files, etc.) and can also include sound generated by applications operating on the mobile computing device 350.

The mobile computing device 350 can be implemented in a number of different forms, as shown in the figure. For example, it can be implemented as a cellular telephone 380. It can also be implemented as part of a smart-phone 382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Another embodiment of a method 400 for mitigating a cyberattack configured to be executed by the system 200 is shown in FIG. 8. The method 400 is similar to the method 100 shown in FIGS. 1-7, and described herein. Accordingly, similar reference numbers in the 400 series indicate features that are common between the method 400 and the method 100. The description of the method 100 is incorporated by reference to apply to the method 400, except in instances when it conflicts with the specific description and the drawings of the method 400.

The method 400 shown in FIG. 8 follows the same operational steps as the method 100 described above and utilizes the same system components of the system 200 as described above. The method 400 differs from the method 100 in that the determination of the first image of the software being under attack is carried out at a customer level 405 instead of the developer level 102 or operational level 104, as described above.

In particular, as can be seen in FIG. 8, a customer utilizing the software in an aircraft engine (i.e. engines 213, 214) or similar application may prefer to choose when to deploy a second image of the software, as opposed to this occurring automatically via the software deployment management system 204C. After the images are loaded into a queue as described above, which may be stored, for example, in the data store 206 or locally in a customer's system, the customer may utilize the queue in order to selectively have the image or images deployed. This decision may be based on the customer's own determination of whether the first image is under attack via direct access to the attack detection tool 204D of the system 200, or utilization of its own detection tool (see FIG. 8 which shows the attack detection tool 204D located at the customer level 405 instead of the developer level 402 or operational level 404).

In other embodiments, the customer may have knowledge or intelligence of when a cyberattack will be occurring in the future, as opposed to responding reactively after a cyberattack has begun. Thus, the customer can choose when to deploy the second image from the queue preemptively based on the knowledge or intelligence of when the cyberattack on the first image will occur. Step 446 in FIG. 8 shows that the customer may either determine that the first image is under attack, or may predict that attack will occur.

In operation, the customer may be in communication with an operator of the method 400 and system 200 that can deploy the new image based on reception of the customer's request (see operational step 450A in FIG. 8). In some embodiments, the customer may have access to a customer user device 204F (see FIG. 2) which is operably and communicatively connected to the software deployment management system 204C and is configured to transmit a signal or message to the software deployment management system 204C (see step 450A in FIG. 8). The signal or message instructs the software deployment management system 204C to deploy the second image from the queue in response to determining that an attack will take place or that an attack has begun. Once this signal or message has been received by the software deployment management tool 204C, the software deployment management system 204C then proceeds to deploy the second image of the software to the operating system of the engines 213, 214 (see step 450B in FIG. 8), and the method 400 proceeds as described above with regard to the method 100.

The disclosed methods 100, 400 and system 200 provide a set of processes and tools that enable creation of multiple software images that are functionally equivalent, but structurally different (“FESD”). For example, the software would produce the same system level outputs, but are different at the binary/program flow level. This allows for a cost-effective method of implementing a “diverse redundancy” approach at the binary level for certified systems to reduce and limit the potential impact from identified security vulnerabilities that depend on the binary/program flow of a piece of software. The methods 100, 400 and system 200 include a set of tools to create the multiple FESD software images, a set of processes and tools to enable verification of the N different versions of the software without incurring N times the base cost to verify a single one, use of secure update capabilities in the deployed system to enable these software images to be securely deployed at a tactically relevant pace considering adversary capabilities, and a set of processes to manage the deployment of a particular software image to the fleet to manage when new FESD software images should be generated and verified.

The disclosed methods 100, 400 and system 200 would enable fully certified (i.e. has completed the entire safety and/or airworthiness certification processes) incident response at a significantly decreased time, and would enable incident response processes to proceed at a pace faster than safety/airworthiness processes can be executed. This will be an enabler to meet required cyber resiliency and cyber survivability requirements while also retaining existing, proven safety processes.

The disclosed methods 100, 400 and system 200 advantageously provide creation of FESD software images with automated tools at the time the system is in development, which will significantly reduce the cost of certifying extra versions. The disclosed methods 100, 400 and system 200 also advantageously provide availability of FESD software images that will significantly reduce the time needed to resume operation after a cyber security incident. The disclosed methods 100, 400 and system 200 also advantageously provide availability of FESD software images that will significantly increase the cost incurred by an attacker to remain effective. Moreover, the method 400 provides “first strike” capabilities by proactively pushing these updates at the outset of a conflict, thereby reducing the likelihood that adversaries would be able to deploy cyberattacks at a tactically critical moment of the conflict.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A method for mitigating a cyberattack, the method comprising
automatically creating, via a software image generation tool, a first image of a software system including a first code level layout and configured to output a first system level output based on a first system level input,
automatically creating, via the software image generation tool, a second image of the software system including a second code level layout different than the first code level layout and configured to output a second system level output equal to the first system level output based on a second system level input equal to the first system level input,
verifying and validating, via a software verification and validation tool, the first and second images of the software system so as to produce first verification and validation data indicative of the verification and validation of the first and second images,
certifying the first and second images based on the first verification and validation data,
deploying, via a software deployment management subsystem, the first image of the software system on a first operating system,
automatically detecting, via an attack detection tool, a first cyberattack being executed on the first image of the software system operating in the first operating system, and
in response to detecting the first cyberattack being executed on the first image of the software system operating on the first operating system, deploying, via the software deployment management subsystem, the second image of the software system on the first operating system in order to disrupt the first cyberattack on the first image of the software system.

2. The method of claim 1, wherein the automatic verification and validation of the first image of the software system includes receiving initial software specifications and automatically determining whether the first image of the software system meets the initial software specifications.

3. The method of claim 2, wherein the automatic creation of the second image is carried out after the automatic determination of whether the first image of the software system meets the initial software specifications, and wherein the automatic verification and validation of the second image of the software system includes determining whether the second image of the software system meets the initial software specifications.

4. The method of claim 3, wherein the initial software specifications include requirement metrics and target values that the first and second images must meet, and wherein the determination of whether the first and second images meet the initial software specifications includes executing testing of the first and second images and comparing results of the testing to the requirement metrics and target values in order to determine whether the first and second images meet the requirement metrics and target values.

5. The method of claim 4, further comprising:
storing, via the software deployment management subsystem, the first verification and validation data in a data store, the first verification and validation data being indicative of the first and second images meeting the requirement metrics and target values of the initial software specifications;
compiling, via the software deployment management subsystem, the first verification and validation data in a packaged format; and
transmitting, via the software deployment management subsystem, the compiled first verification and validation data to an external certifier to have the first and second images certified.

6. The method of claim 1, further comprising:
in response to detecting that a first cyberattack being executed on the first image of the software system operating in the first operating system, automatically assigning, via the software deployment management subsystem, a severity value to the first cyberattack.

7. The method of claim 6, wherein the severity value is based on a number of a plurality of severity factors present in the first cyberattack, wherein the severity value is a binary number in a specified range of numbers, and wherein the severity value is proportional to the number of the plurality of severity factors present in the first cyberattack.

8. The method of claim 7, further comprising:
in response to detecting that a first cyberattack being executed on the first image of the software system operating in the first operating system, automatically assigning, via the software deployment management subsystem, a risk value of deploying the second image of the software system.

9. The method of claim 8, wherein the risk value is based on a number of a plurality of risk factors of deploying the second image of the software system, wherein the risk value is a binary number in a specified range of numbers, and wherein the risk value is proportional to the number of the plurality of risk factors of deploying the second image of the software system.

10. The method of claim 9, further comprising:
automatically comparing, via the software deployment management subsystem, the severity value with the risk value and, in response to the severity value being greater than the risk value, deploying the second image of the software system.

11. A method for mitigating a cyberattack, the method comprising
creating a first image of a software system,
creating a second image of the software system different than the first image,
automatically verifying and validating the first and second images of the software system,
deploying the first image of the software system on a first operating system,
receiving an indication that a first cyberattack is being executed or will be executed on the first image of the software system operating in the first operating system, and
in response to receiving the indication that the first cyberattack is being executed or will be executed on the first image of the software system operating on the first operating system, deploying the second image of the software system on the first operating system in order to disrupt the first cyberattack on the first image of the software system.

12. The method of claim 11, wherein the receiving of the indication that the first cyberattack is being executed includes receiving an alert from a customer managing the first operating system that the first cyberattack will be executed on the first image of the software system.

13. The method of claim 11, wherein the receiving of the indication that the first cyberattack is being executed includes detecting that the first cyberattack is being executed on the first image of the software system.

14. The method of claim 13, wherein the creation of the first image of the software system includes creating a first code level layout configured to output a first system level output based on a first system level input, and wherein the creation of the second image of the software system includes creating a second code level layout different than the first code level layout configured to output a second system level output equal to the first system level output based on a second system level input equal to the first system level input.

15. The method of claim 14, wherein the automatic verification and validation of the first image of the software system includes receiving initial software specifications and automatically determining whether the first image of the software system meets the initial software specifications, wherein the creation of the second image is carried out after the automatic determination of whether the first image of the software system meets the initial software specifications, and wherein the automatic verification and validation of the second image of the software system includes determining whether the second image of the software system meets the initial software specifications.

16. The method of claim 15, wherein the initial software specifications include requirement metrics and target values that the first and second images must meet, and wherein the determination of whether the first and second images meet the initial software specifications includes executing testing of the first and second images and comparing results of the testing to the requirement metrics and target values in order to determine whether the first and second images meet the requirement metrics and target values.

17. The method of claim 13, further comprising:
in response to detecting that a first cyberattack being executed on the first image of the software system operating in the first operating system, automatically assigning a severity value to the first cyberattack,
wherein the severity value is based on a number of a plurality of severity factors present in the first cyberattack, wherein the severity value is a binary number in a specified range of numbers, and wherein the severity value is proportional to the number of the plurality of severity factors present in the first cyberattack.

18. The method of claim 17, further comprising:
in response to detecting that a first cyberattack being executed on the first image of the software system operating in the first operating system, automatically assigning a risk value of deploying the second image of the software system,
wherein the risk value is based on a number of a plurality of risk factors of deploying the second image of the software system, wherein the risk value is a binary number in a specified range of numbers, and wherein the risk value is proportional to the number of the plurality of risk factors of deploying the second image of the software system.

19. The method of claim 18, further comprising:
automatically comparing the severity value with the risk value and, in response to the severity value being greater than the risk value, deploying the second image of the software system.

20. A system for mitigating a cyberattack, comprising
a software image generation tool configured to automatically create a first image of a software system including a first code level layout and configured to output a first system level output based on a first system level input, and configured to automatically create a second image of the software system including a second code level layout different than the first code level layout and configured to output a second system level output equal to the first system level output based on a second system level input equal to the first system level input,
a software verification and validation tool configured to automatically verify and validate the first and second images of the software system so as to produce first verification and validation data indicative of the verification and validation of the first and second images, wherein an external certification processor is configured to certify the first and second images based on the first verification and validation data,
a software deployment management subsystem configured to deploy the first image of the software system on a first operating system, and
an attack detection tool configured to detect a first cyberattack being executed on the first image of the software system operating in the first operating system,
wherein the software deployment management subsystem is further configured to, in response to detecting the first cyberattack being executed on the first image of the software system operating on the first operating system, deploy the second image of the software system on the first operating system in order to disrupt the first cyberattack on the first image of the software system.
